(19) United States
(12) Patent Application Publication
(10) Pub. No.: US 2016/0062319 A1
(43) Pub. Date: Mar. 3, 2016

(54) SMART WATCH FOR ENABLING WIRELESS CHARGING

(71) Applicant: Samsung Electronics Co., Ltd., Suwon-si (KR)

(72) Inventors: Tong H. Kim, Suwon-si (KR); Em-Hwan Kim, Yongin-si (KR); Jung-Su Kim, Yongin-si (KR); Sung-Woo Moon, Seongnam-si (KR); Jun-Ho Lee, Hwaseong-si (KR); Jae-Hun Choe, Yongin-si (KR)

(21) Appl. No.: 14/730,451

(22) Filed: Jun. 4, 2015

(30) Foreign Application Priority Data
Aug. 29, 2014 (KR) 10-2014-0114479

(51) Int. Cl. G04G 19/00; H02J 7/02; G04G 21/08

(52) U.S. Cl. CPC G04G 19/00; G04G 21/08; H02J 7/025

(57) ABSTRACT

A smart watch capable of wireless charging includes a bezel which functions as a smart function operation circuit and a touchable display and a wrist band connected to the bezel. The bezel is separated from a power receiving coil.

### CROSS-REFERENCE TO RELATED APPLICATION

This application claims priority under 35 U.S.C. §119 to Korean Patent Application No. 10-2014-0114479 filed on Aug. 29, 2014, the disclosure of which is hereby incorporated by reference in its entirety.

### BACKGROUND

1. Field

Example embodiments relate to a smart device. Example embodiments further relate to a smart watch capable of being wirelessly charged.

2. Description of Related Art

With continued development of digital technologies, various electronic devices, such as a mobile communication terminal, a personal digital assistant (PDA), an electronic organizer, a smart phone, a tablet personal computer (PC), and the like, which communicate and process personal information while mobile, have been released.

Specifically, wearable devices among mobile devices, in which smart functions are configured, have been enjoying recent emergence. Examples include smart watches, smart glasses, and the like.

Wearable devices commonly include a battery for supplying power, and a method of attaching to a specific wired power charging device is primarily employed. However, the degree of charging of the battery is limited due to device characteristics, and the physical connection to the battery and charging sequence may be inconvenient or difficult when the battery is to be charged.

### SUMMARY

Example embodiments of the inventive concepts provide a smart watch in which a charging distance and a charging angle are less restrictive while the resulting design and configuration are simplified.

The technical objectives of the inventive concept are not limited to the above disclosure; other objectives may become apparent to those of ordinary skill in the art based on the following descriptions.

In an aspect, a smart watch comprises: a bezel configured to function as a smart function operation circuit and a touchable display; and a wrist band connected to the bezel, wherein a power receiving coil is separated from the bezel.

In some embodiments, the power receiving coil is positioned in the wrist band.

In some embodiments, the power receiving coil comprises a coil using a magnetic resonance coupling, and enables wireless charging of the smart watch.

In some embodiments, the bezel further comprises a battery.

In some embodiments, the battery stores energy received from the power receiving coil.

In an aspect, a smart watch comprises: a bezel including a smart function operation circuit and a charging battery; and a wrist band connected to the bezel and including a power receiving coil, wherein wireless charging is available to the smart watch using the power receiving coil.

In some embodiments, the power receiving coil controls charge capacity independent of a size of the bezel.

In some embodiments, the power receiving coil is provided in both first and second portions of the wrist band and wherein the number of windings of the coil is independent of the size of the bezel.

In some embodiments, the wrist band comprises a rubber material and wherein the rubber material surrounds the power receiving coil.

In some embodiments, the power receiving coil comprises a coil configured to employ a magnetic resonance coupling.

In some embodiments, the power receiving coil comprises copper.

In some embodiments, the charging battery stores energy received from the power receiving coil.

In some embodiments, the bezel comprises a printed circuit board (PCB) substrate including the smart function operation circuit.

In some embodiments, the power receiving coil is connected to the PCB substrate.

In some embodiments, the PCB substrate comprises: an application processor (AP) configured to interpret and execute an external program instruction; a memory configured to store information of an operating system (OS) of the smart watch and processed data; a power source unit configured to control an on/off switch of the smart watch; and a charger configured to transfer power received from the wrist band to the charging battery.

In an aspect, a smart watch comprises: a bezel operable as a smart function operation circuit; a charging battery on the bezel, the charging battery including supporting charging circuitry; a wrist band coupled to the bezel; and a power receiving coil in the wrist band, the power receiving coil including a coil portion configured to employ magnetic resonance coupling and a terminal portion, the terminal portion constructed and arranged to electrically couple the coil portion to the supporting charging circuitry of the charging battery.

In some embodiments, the coil portion of the power receiving coil is positioned exclusively within the watch band.

In some embodiments, the watch band includes first and second portions coupled to opposed sides of the bezel.

In some embodiments, the coil portion of the power receiving coil comprises copper.

In some embodiments, charge capacity of the power receiving coil is determined independent of a size of the bezel.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is an exploded perspective view illustrating a general smart watch;

FIG. 2 is a view illustrating an example in which a coil is mounted under a battery;

FIG. 3 is a conceptual view illustrating a method of wireless charging a smart watch by a charging pad;

FIG. 4 is a conceptual view illustrating a smart watch in accordance with an embodiment of the inventive concepts;

FIG. 5 is a block diagram of the smart watch shown in FIG. 4;

FIG. 6A is a conceptual block diagram of a relationship between a smart watch receiver system and an external transmission system;

FIG. 6B is a simple equivalent circuit diagram illustrating a transmitting resonance unit and a receiver resonance unit shown in FIG. 6A;

FIGS. 7A to 7D are views illustrating various arrangements of a smart watch and a charging pad in accordance with embodiments of the inventive concepts;

FIG. 8 is a view illustrating an example of a method of forming a coil in a wrist band; and

FIGS. 9A to 9D are views illustrating various uses of a smart watch in which a coil is embedded in accordance with an embodiment of the inventive concepts.

### DETAILED DESCRIPTION

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concepts to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an embodiment can be implemented differently, functions or operations described in a particular block may occur in a different way from a flow described in the flowchart. For example, two consecutive blocks may be performed simultaneously, or the blocks may be performed in reverse according to related functions or operations.

Hereinafter, exemplary embodiments of the inventive concepts will be described in detail with reference to the accompanying drawings.

In general, in small-sized wearable mobile devices such as a smart watch, a role of a battery charging apparatus is significant. While sufficient power storage capacity, allowing for longer usage time is important, as well as the charging configuration for replenishing power to the device.

In some charging configurations for a smart watch, a Universal Serial Bus (USB) connection has become popular. Also used are wireless charging methods, which have become popular in recent technological trends for their ease of use.

Wireless charging methods commonly employ a wireless power transfer (WPT) technique. The WPT technique is a technique in which power is wirelessly supplied to appliances or electric devices. The WPT technique thus provides a configuration in which wireless charging is possible without the need for a direct-wired connection, for example, without the need for an additional socket and wired cable.

In various approaches for WPT, an electromagnetic induction method, a magnetic resonance method, and the like may be employed. Presently, the electromagnetic induction approach is widely deployed.

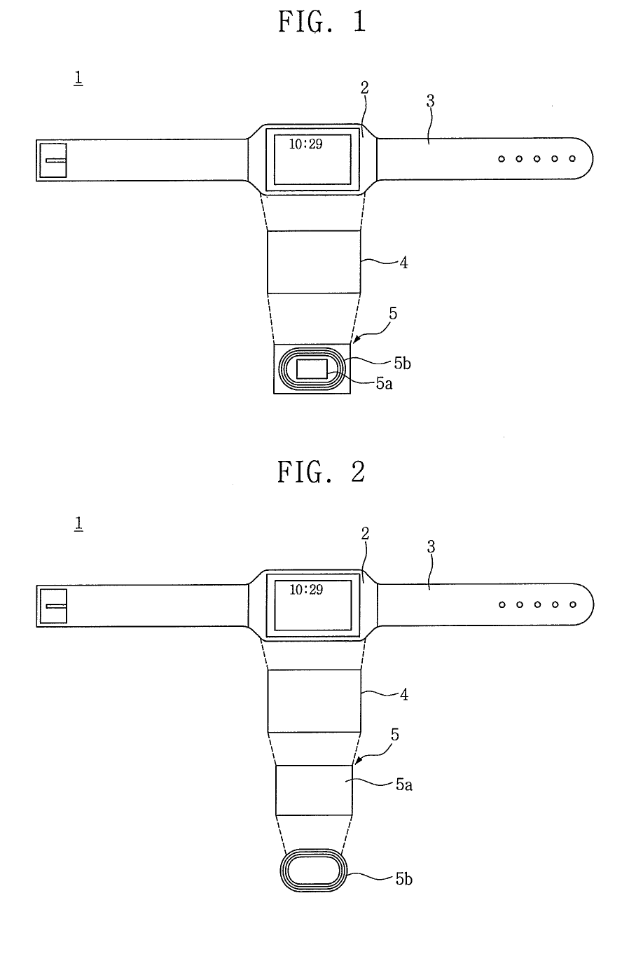

FIG. 1 is an exploded perspective view illustrating a general smart watch 1.

A smart watch 1 which employs an electromagnetic induction method for WPT will be described with reference to FIG. 1.

Referring to FIG. 1, the smart watch 1 includes a bezel 2 and a wrist band 3. For purposes of the present disclosure, the bezel 2 is referred to as a unit having more complex functions than a simple display unit of glass or a transparent material. More specifically, in contemporary smart watches, the bezel 2 can commonly include certain componentry, such as a printed circuit board (PCB) substrate 4 and a charging unit 5.

In some configurations, the bezel 2 serves as a touchable display of the smart watch 1. The PCB substrate 4, which can include a plurality of circuit units (not shown) can be provided within the bezel 2.

Although not shown in the drawing, the PCB substrate 4 may optionally further include a transceiver capable of wireless communication, a microprocessor, a memory, and other componentry used for proper functioning of the smart watch.

Meanwhile, in some configurations, the charging unit 5 is provided under the PCB substrate 4.

The charging unit 5 may store electrical power for use by the smart watch 1 and appropriately supply the power so as to operate various functions of the smart watch 1. In some configurations, the charging unit 5 includes a battery 5a and a coil 5b.

More specifically, the charging unit 5 includes the battery 5a capable of storing the power, and the coil 5b configured in a spiral shape at one or more surfaces of the battery 5a or surrounding the battery 5a. The battery 5a and the coil 5b may be configured to receive electrical energy from an external transmission unit, such as a power transmitter/receiver, and thus, may be configured to wirelessly charge the battery 5a. That is, the charging unit 5 may receive electrical energy, which is induced from a coil (not shown) mounted in the external transmission unit, the electrical energy is transferred to current in the coil 5b and the induced current of the coil 5b can be used to charge the battery 5a. Meanwhile, the coil 5b may be provided on or under the battery 5a depending on predetermined configurations for the intended product.

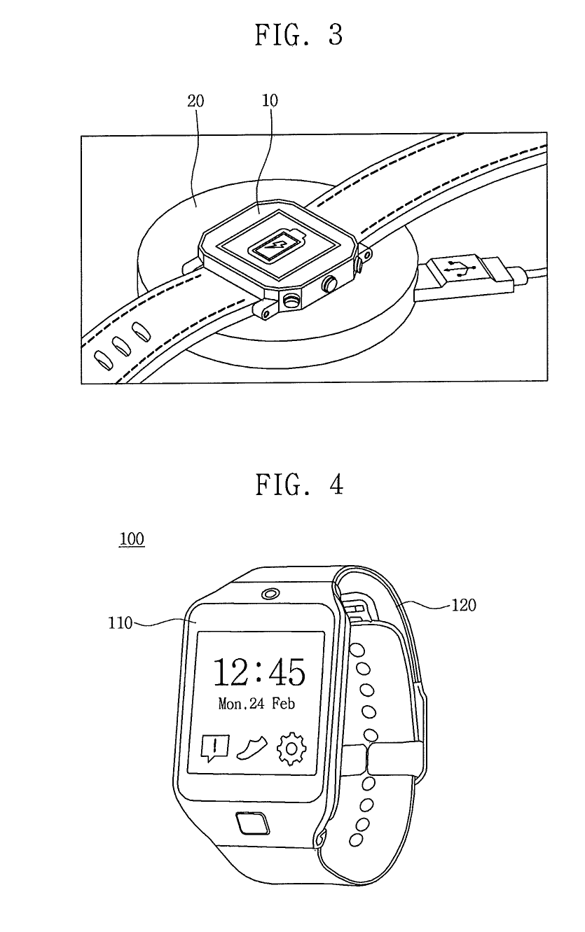

FIG. 2 is a view illustrating an example in which the charging unit 5 includes a coil 5b mounted under a battery 5a. Referring to FIG. 2, in the present configuration, a smart watch 1 includes a bezel 2 and a wrist band 3. The bezel 2 includes a PCB substrate 4 and a charging unit 5.

The bezel 2 serves as a touchable display of the smart watch 1. The PCB substrate 4 including a plurality of circuit units (not shown) is provided within the bezel 2.

The charging unit 5 is provided under the PCB substrate 4. More specifically, the coil 5b is provided under the battery 5a, and the coil 5b and battery 5a are in turn provided under the PCB substrate 4. That is, in the present configuration the coil 5b may be mounted on or under the battery 5a rather than surrounding the battery 5a.

As described above, in order to apply a wireless charging method, a power receiving coil may be mounted directly inside the bezel 2 of the smart watch 1. A method of charging the smart watch 1 using the wireless charging method will now be described with reference to the following drawing.

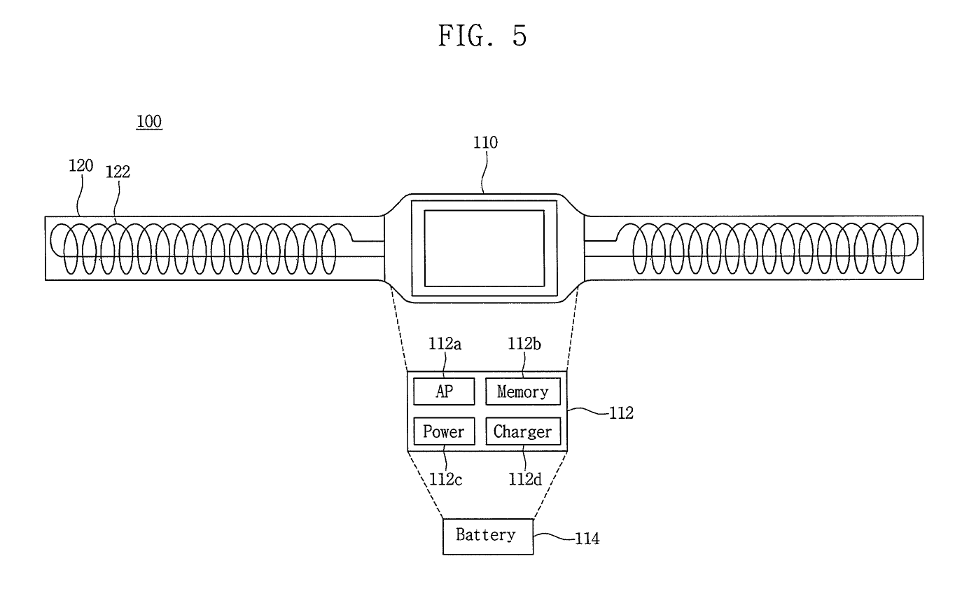

FIG. 3 is a conceptual diagram a method of wireless charging of a smart watch 10 by a charging pad 20.

Referring to FIG. 3, the smart watch 10 to be charged is placed on the charging pad 20. In this case, since the smart watch 10 is charged without a wired connection between the smart watch 10 and the charging pad 20, the smart watch 10 may be wirelessly charged.

However, referring to FIG. 3, even though wireless charging is possible between the smart watch 10 and the charging pad 20, it may be seen that placement of the smart watch 10 at an exact location on the charging pad is needed. Such a charging method is referred to as a tightly coupled method.

Further, since the wireless charging is only possible within a limited contactless range of only several centimeters of height, for example, 3 cm in height, wireless charging range is therefore somewhat limited. As a result, the charging operation may become difficult or inconvenient.

Meanwhile, as described herein, the power receiving coil 5b (see FIGS. 1 and 2) is mounted within the limited area of the bezel 2 (see FIG. 1) of the smart watch 1. In this illustrated configuration, in other words, the size of the bezel of the smart watch has a proportional relationship to charge capacity. Therefore, in a configuration where the power receiving coil surrounds the charging part to increase power receiving efficiency, the size of the bezel needs to be increased so as to increase the foot area ratio of the coil. Otherwise, when the power receiving coil is mounted on or under the charging unit, the thickness of the bezel needs to increase.

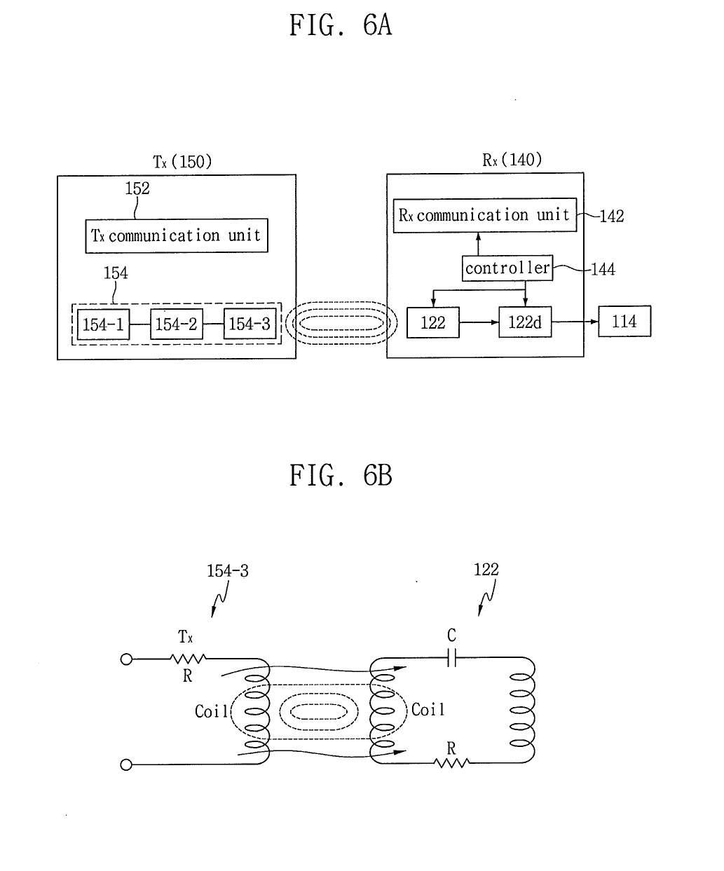

FIG. 4 is a conceptual diagram a smart watch 100 in accordance with an embodiment of the inventive concepts.

Referring to FIG. 4, the smart watch 100 in accordance with the embodiment of the inventive concepts includes a bezel 110 capable of displaying or selecting a smart operation function, and a wrist band 120 in which a charging coil is embedded.

According to some example embodiments of the inventive concepts, the charging coil is provided in the wrist band 120 rather than in the bezel 110 to enable wireless charging, and thus, a degree of freedom of the wireless charging operation may be improved. Additionally, according to some example embodiments of the inventive concepts, power receiving efficiency may be improved, and the size of the bezel 110 may be reduced or area efficiency of the bezel 110 may be improved in accordance with desired design parameters.

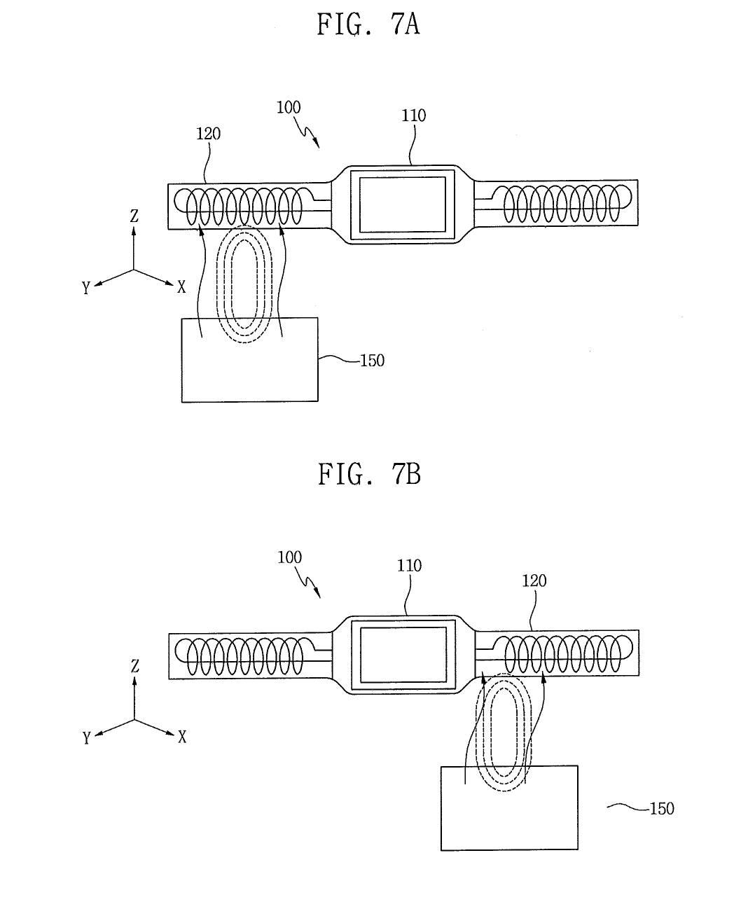

FIG. 5 is a block diagram illustrating the smart watch 100 shown in FIG. 4.

Referring to FIG. 5, the smart watch 100 includes the bezel 110 and the wrist band 120,

The bezel 110 includes a PCB substrate 112 including a plurality of the circuit units, and a battery 114.

In some embodiments, the PCB substrate 112 can include an application processor (AP) 112a, a memory 112b, a power source unit 112c, and a charger 112d.

In some embodiments, the AP 112a operates as a central processing unit (CPU) of the smart watch 100. The AP 112a reads program instructions, which are input to the smart watch 100 to be executed according to the read instructions. In addition, the AP 112a may perform arithmetic and logical operations and statistical processing on corresponding data.

In some embodiments, the memory 112b stores basic information of an operating system (OS) of the smart watch 100 and processed data, etc.

In some embodiments, the power source unit 112c controls an on/off function of the smart watch 100 and maintains power.

In some embodiments, the charger 112d transfers the power received from the wrist band 120 to the battery 114.

Although the PCB substrate 112 is described herein as being configured of a simple circuit unit for convenience of descriptions, embodiments of the PCB substrate 112 are not thus limited and various circuit units may be optionally included. For example, the PCB substrate 112 may further include a transceiver capable of wireless communication, a speaker, and other suitable electronics.

In some embodiments, the battery 114 may be used to store the received power. In some embodiments, the battery 114, for example, may comprise a lithium ion battery.

Meanwhile, according to embodiments of the inventive concepts, a coil 122 may be positioned within the wrist band 120. The wrist band 120, in turn, is connected to the bezel 110, both mechanically, for supporting the bezel, and electrically, for electrical connection of the coil 122 to the electronics and battery included in the bezel 110.

In some embodiments, the coil 122 in accordance with the embodiment of the inventive concept may comprise a magnetic resonant coil. That is, according to some example embodiments of the inventive concepts, the coil 122 positioned within the wrist band 120 may wirelessly receive power transfer from an external transmission unit through a magnetic resonant coupling.

Since the coil 122 is mounted within the wrist band 120, the size of the bezel 110 may be reduced and the area efficiency of the bezel 110 may be improved. In addition, the thickness of the bezel 110 may also be reduced, making the watch 100 less bulky and more streamlined. As a result, wearing of the smart watch 100 may be made to be a more comfortable experience for the end user.

According to some example embodiments of the inventive concepts, the magnetic resonant coil can be used with alleviated restrictions on charging distance and a charging angle relative to the external transmission unit.

In one embodiment, assuming that an operational frequency of a magnetic resonance method is 6.78 MHz, as compared to that of a magnetic induction method within a range of 100 KHz to 200 KHz, it may be seen that the charging distance and the charging angle are more flexible by using the magnetic resonance method. The method described above may be referred to as a loosely coupled method. That is, the smart watch 100 in accordance with embodiments of the inventive concepts may be sufficiently charged with fewer limitations on location or distance from the external transmission unit, as compared to the conventional embodiments.

The smart watch 100 in accordance with embodiments of the inventive concept will now be described in greater detail. Since a greater area is available for the coil 122, for example, both straps of the wrist band 120 can be used for embedding of the coil 122, the number of windings of the coil 122 may be increased. Thus, a Q factor, or power transmission efficiency factor, for the charging system, may be increased.

Referring to another aspect, since the coil 122 is relatively smaller and thinner as an operational frequency of the coil 122 which is a power receiving unit and a voltage of the coil 122 are increased, the smart watch 100 in accordance with the embodiment of the inventive concept may be implemented to have an appropriate size suitable for wearing. In other words, the smart watch 100 in accordance with the embodiment of the inventive concept may be implemented to facilitate mounting components on a mobile device and a wearable device.

Furthermore, since a surface eddy current of the coil 122 which is the power receiver of the smart watch 100 is lower than that of an electromagnetic induction coil, conversion of the received energy to thermal energy is mitigated or prevented, and thus, increase of the temperature of a charging pad which is a transmission unit or the smart watch 100 is mitigated or prevented.

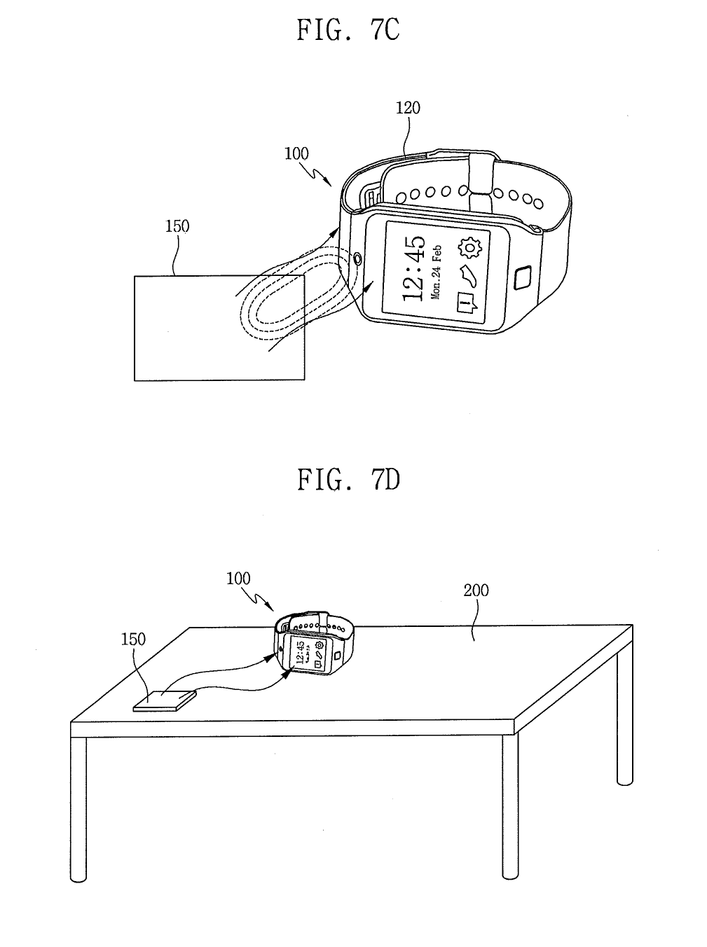

FIG. 6A is a conceptual block diagram of a relationship between a smart watch receiver system 140 and an external transmission system 150. The smart watch receiver system 140 is intended to describe an expanded concept in which a communication function is further included in the smart watch 100 shown in FIG. 5, and is not intended to describe a device that is separated from the smart watch 100.

Referring to FIG. 6A, in some embodiments, the transmission (Tx) system 150 includes a Tx communication unit 152 and a Tx circuit unit 154. The Tx system 150 is provided to be suitable for a magnetic resonance wireless charging system and may substantially comprise a charging pad. In some embodiments, the Tx communication unit 152 may communicate with the smart watch receiver (Rx) system 140 using a predetermined arrangement. For example, the Tx communication unit 152 may communicate using near field communication (NFC), infrared communication, visible light communication, Bluetooth, etc.

In some embodiments, the Tx circuit unit 154 may include an oscillator 154-1, a low pass filter (LPF) 154-2, and a Tx resonance unit 154-3. The oscillator 154-1 wirelessly generates power while oscillating with a predetermined cycle. The LPF 154-2 filters a DC component of the generated power. The Tx resonance unit 154-3 generates a magnetic field in a range of a specific frequency, for example, a resonant frequency. To this end, the Tx resonance unit 154-3 may be provided by a magnetic resonant coil. Furthermore, the Tx system 150 may further include an impedance matching circuit, or other supporting circuitry.

The Rx system 140 in accordance with an embodiment of the inventive concept will now be described. In some embodiments, the Rx system 140 includes an Rx communication unit 142, a controller 144, a coil 122, a charger 122d, and a battery 114. The Rx communication unit 142 may communicate with the Tx system 150 using a predetermined arrangement. For example, the Rx communication unit 142 may communicate using NFC, infrared communication, visible light communication method, Bluetooth, etc.

In some embodiments, the controller 144 may operate to control overall operations of the Rx communication unit 142, the coil 122, and the charger 122d. In some embodiments, the coil 122, the charger 122d, and the battery 114 may be substantially the same as, or substantially similar to, the coil 122, the charger 112d, and the battery 114 included in the smart watch 100 (shown in FIG. 5).

Therefore, in some embodiments, the coil 122 that operates as a receiver may be provided as a magnetic resonant coil and may be configured to resonate with a specific frequency. In such a case, the charger 122d may appropriately control the received power and transfer the received power to the battery 114.

As described above, a resonance phenomenon resulting in vibration with a large amplitude between the Tx resonance unit 154-3 and the Rx resonance unit 122 occurs, and accordingly, under these conditions, the Rx system 140 may be wirelessly charged. In this case, the Tx system 150 may be in a state in which a power source is connected, and the Rx system 140 which is the receiver, may be wirelessly charged within a predetermined distance range from the Tx system 150 using the embedded coil.

In terms of the power source, in sonic embodiments, the Tx system 150 may comprise a source device which supplies the power source and the Rx system 140 may be a target device to which the power source is supplied. As a result, energy is transferred from the source device to the target device using a magnetic resonance coupling phenomenon which occurs between the Tx system 150 which is the source device and the Rx system 140 which is the target device, and thus, the target device may be charged by the power source.

FIG. 6B is a simple equivalent circuit diagram showing the Tx resonance unit 154-3 and the Rx resonance unit 122 shown in FIG. 6A. Referring to FIG. 6B, the Tx resonance unit 154-3 includes a resistance component R, and the Rx resonance unit 122 includes a resistance component R and a capacitance component C. However, embodiments of the inventive concepts are not limited to that shown in the drawing, and, in other embodiments, the Tx resonance unit 154-3 may also include the capacitance component C. The configuration is not limited by the content of the inventive concepts, and it is used only to describe the simple equivalent circuit.

Referring to FIG. 6B, it may be seen that a magnetic resonance phenomenon occurs between both coils of the Tx resonance unit 154-3 and the Rx resonance unit 122. That is, a magnetic field which vibrates with a resonant frequency is generated in the coil of the Tx resonance unit 154-3, and then, as a result, energy may be intensively transferred to the coil of the Rx resonance unit 122 designed with the same, or substantially similar, resonant frequency.

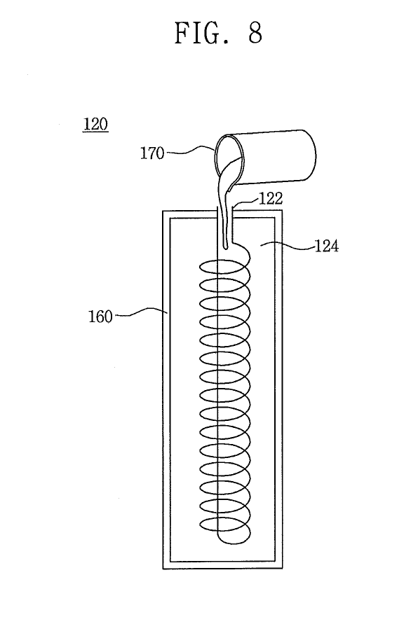

FIGS. 7A to 7D are views showing various arrangements of a smart watch 100 and a Tx system 150 which is a charging pad in accordance with embodiments of the inventive concept.

First, referring to FIG. 7A, a magnetic resonant coupling occurs between a coil 122 embedded in a wrist band 120 and the Tx system 150. In this case, the Tx system 150 which is the charging pad may be located close to a side of the wrist band 120 rather than a center of the smart watch 100 or at an exact location relative to the smart watch 100.

In other words, even though the smart watch 100 is located at a position that is separated from the Tx system 150 by a predetermined distance or more in the X, Y, and Z directions, that is, does not directly contact the Tx system 150 or is not located at a closest location to the Tx system 150, the smart watch 100 may still be wirelessly charged.

FIG. 7B is a view showing a part of a side of the wrist band 120 is located to overlap the Tx system 150. Referring to FIG. 7B, it may be seen that an overlap range between the Tx system 150 and the wrist band 120 is smaller compared to that of FIG. 7A, even in this case, the smart watch 100 may still be wirelessly charged. Likewise, the smart watch 100 may be located separate from the Tx system 150 by a predetermined distance or more in the X, Y, and Z directions, and the smart watch 100 may still be wirelessly charged.

FIG. 7C is a view showing an example in which the smart watch 100 may be wirelessly charged from the Tx system 150 even though the wrist band of the smart watch 100 is not fully unfolded or opened. Referring to FIG. 7C, the smart watch 100 may wirelessly receive the power from the Tx system 150 even though the wrist band 120 of the smart watch 100 is bent or closed.

Although repeatedly described, since the power may be transferred by a magnetic resonance phenomenon which occurs between the coil embedded in the wrist band 120 and the Tx system 150, the smart watch 100 may be wirelessly charged. That is, since precise location of the bezel 110 and the smart watch 100 relative to the Tx system 150 and, precise coupling therebetween, are not required, the charging method of the smart watch 100 in accordance of the embodiment of the inventive concept may be more tolerant of placement of the watch 100.

FIG. 7D is a view showing a position of the smart watch 100 and the Tx system 150 in the space of a user.

Referring to FIG. 7D, the Tx system 150 is located on a portion of a table 200 of the user. As shown, the user may place the smart watch 100 at a portion of the table 200 spaced apart from the Tx system 150 while actively engaging in use of the features of the smart watch 100. In this example, wireless charging occurs between the Tx system 150 and the smart watch 100. Since continuous wireless charging is possible during use of the smart watch 100, convenience of the charging operation is therefore improved.

A distance for wireless charging between the Tx system 150 and the smart watch 100 may be substantially about tens of centimeters, and may extend into a range of 1 m to 2 m when a Q factor of the coil is increased. Therefore, a range of wireless charging may extend and a wireless charging method may be more freely available to the user, with fewer restrictions. A coil 122 embedded in the wrist band 120 is employed, and thus, power receiving efficiency and simplicity of the smart watch 100 may be enhanced.

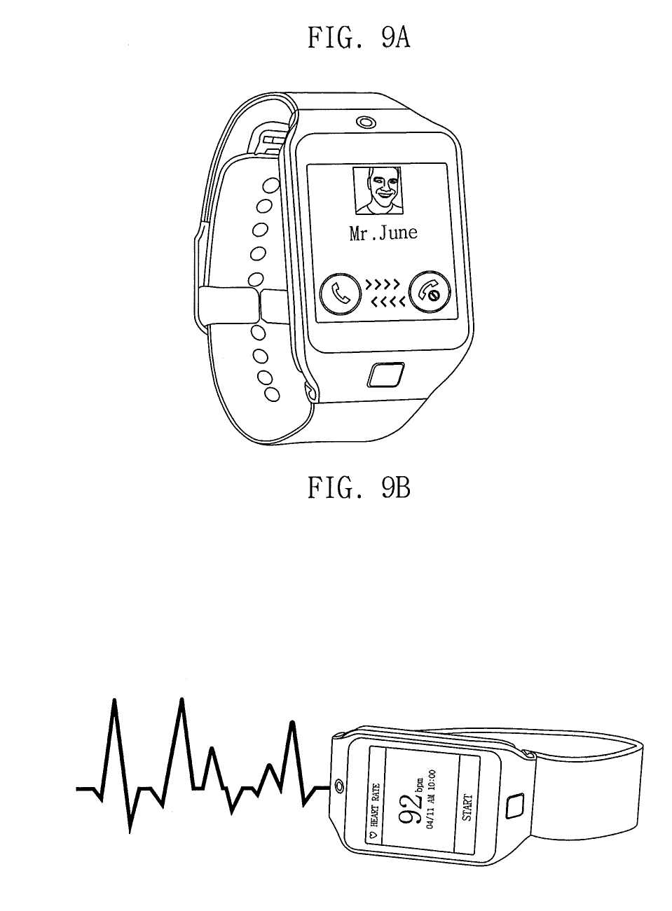

FIG. 8 is a view showing an example of a method of forming a coil 122 in a wrist band 120.

Referring to FIG. 8, in some embodiments, a cast 160 or a mold which is suitable for a shape of the wrist band 120 is provided. The coil 122 may be loaned in the cast 160, the cast 160 may be filled with a liquid material, for example, a liquid rubber 170, and thus, the coil 122 may be securely supported. The liquid rubber 170 may additionally serve as an inner shield material 124 when the liquid rubber 170 is solidified, may support the coil 122, and may also serve as a complete electrical insulation between two terminals of the coil 122.

Further, the two terminals of the coil 122 may be provided to connect the coil to the PCB substrate 112 (see FIG. 5). As a result, wireless energy transferred to the coil 122 may be in turn transferred to the PCB substrate (see FIG. 5). In various embodiments the coil 122 may be formed of a material which is readily suited for curving or bending, for example, copper.

The present example is shown for illustrative purposes only, and various embodiments of a method of forming the coil 122 are possible.

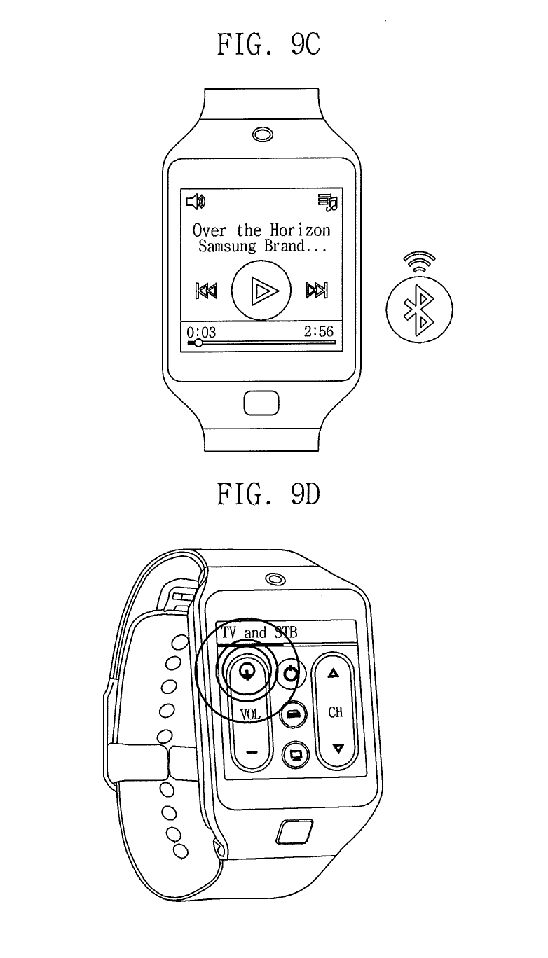

FIGS. 9A to 9D are views showing various uses of a smart watch 100 in which a coil is embedded in accordance with an embodiment of the inventive concept.

Referring to FIG. 9A, the smart watch 100 may be used to make a voice and/or video call. Since the smart watch 100 is worn on the user's wrist, the watch 100 permits a user to freely call without concern about missing important calls during pursuit of other tasks. Further, the smart watch 100 such as a smart phone may further be configured to receive a message, an email, and the like.

Referring to FIG. 9B, in some embodiments, the smart watch 100 may be used as an exercise assistant device. For example, when a heart rate sensor is mounted in the smart watch 100, a user may obtain information by checking and maintaining a heart rate when exercising. The smart watch 100 may assist to control a speed depending on a heart rate change so that the user may effectively exert himself. Further, the smart watch 100 may be used as a pedometer using an acceleration sensor, and thus, the user the smart watch 100 may be helpful to a user's health care by checking the number of walking steps, distance traveled, and calories expended during a specified time period, for example, a day.

Referring to FIG. 9C, the smart watch 100 may optionally be used to listen to music by connecting to an embedded speaker or a Bluetooth headphone.

Referring to FIG. 9D, the smart watch 100 may be used as a remote controller of a TV or a set-top box. Therefore, a channel and a volume of the TV or the set-top box may be controlled by the smart watch 100.

As described above, the smart watch 100 in accordance with the embodiment of the inventive concept may provide various functions. In addition, since the smart watch 100 may be readily charged within a predetermined distance range from a charging pad free of certain constraints imposed by conventional approaches. The smart watch 100 may be charged from time to time when in the vicinity of the charging station, and thus, the smart watch 100 may be continuously used for a long time.

In addition to the disclosed device, the use of smart watch 100 may be expanded and applied to wearable devices, for example, smart glasses, smart clothes, and the like. That is, when a magnetic resonant coil is provided to be surrounded in a shield shape, a charging method may be free and power efficiency may be improved.

According to the smart watch in accordance with the embodiments of the inventive concept, as degrees of freedom of a charging method and a charging distance are increased, charging can be easy and charging efficiency can be improved.

The inventive concepts can be readily applied to a mobile device, and more specifically, a wearable device.

While the exemplary embodiments of the inventive concepts and their advantages have been described in detail, it should be understood that various changes, substitutions, and alterations may be made herein without departing from the scope of the inventive concepts as defined by the appended claims.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims, In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A smart watch, comprising:
a bezel configured to function as a smart function operation circuit and a touchable display; and
a wrist band connected to the bezel,
a power receiving coil separated from the bezel.

2. The smart watch according to claim 1, wherein the power receiving coil is positioned in the wrist band.

3. The smart watch according to claim 2, wherein the power receiving coil comprises a coil using a magnetic resonance coupling, and enables wireless charging of the smart watch.

4. The smart watch according to claim 1, wherein the bezel further comprises a battery.

5. The smart watch according to claim 4, wherein the battery stores energy received from the power receiving coil.

6. A smart watch, comprising:
a bezel including a smart function operation circuit and a charging battery; and
a wrist band connected to the bezel and including a power receiving coil, wherein wireless charging is available to the smart watch using the power receiving coil.

7. The smart watch according to claim 6, wherein the power receiving coil controls charge capacity independent of a size of the bezel.

8. The smart watch according to claim 7, wherein the power receiving coil is provided in both first and second portions of the wrist band and wherein the number of windings of the coil is independent of the size of the bezel.

9. The smart watch according to claim 6, wherein the wrist band comprises a rubber material and wherein the rubber material surrounds the power receiving coil.

10. The smart watch according to claim 6, wherein the power receiving coil comprises a coil configured to employ a magnetic resonance coupling.

11. The smart watch according to claim 6, wherein the power receiving coil comprises copper.

12. The smart watch according to claim 6, wherein the charging battery stores energy received from the power receiving coil.

13. The smart watch according to claim 6, wherein the bezel comprises a printed circuit board (PCB) substrate including the smart function operation circuit.

14. The smart watch according to claim 13, wherein the power receiving coil is connected to the PCB substrate.

15. The smart watch according to claim 13, wherein the PCB substrate comprises:
an application processor (AP) configured to interpret and execute an external program instruction;
a memory configured to store information of an operating system (OS) of the smart watch and processed data;
a power source unit configured to control an on/off switch of the smart watch; and
a charger configured to transfer power received from the wrist band to the charging battery.

16. A smart watch comprising:
a bezel operable as a smart function operation circuit;
a charging battery on the bezel, the charging battery including supporting charging circuitry;
a wrist band coupled to the bezel; and
a power receiving coil in the wrist band, the power receiving coil including a coil portion configured to employ magnetic resonance coupling and a terminal portion, the terminal portion constructed and arranged to electrically couple the coil portion to the supporting charging circuitry of the charging battery.

17. The smart watch of claim 16 wherein the coil portion of the power receiving coil is positioned exclusively within the watch band.

18. The smart watch of claim 16 wherein the watch band includes first and second portions coupled to opposed sides of the bezel.

19. The smart watch of claim 16 wherein the coil portion of the power receiving coil comprises copper.

20. The smart watch of claim 16 wherein charge capacity of the power receiving coil is determined independent of a size of the bezel.
